(19) United States
(12) Patent Application Publication
(10) Pub. No.: US 2025/0329705 A1
(43) Pub. Date: Oct. 23, 2025

(54) APPARATUS AND METHOD FOR MANUFACTURING SECONDARY BATTERY ELECTRODE PLATE WITH MULTISTAGE COATED PORTIONS

(71) Applicant: SAMSUNG SDI CO., LTD., Yongin-si (KR)

(72) Inventor: Hyunjin Lee, Yongin-si (KR)

(21) Appl. No.: 18/967,382

(22) Filed: Dec. 3, 2024

(30) Foreign Application Priority Data
Apr. 18, 2024 (KR) 10-2024-0052124

(51) Int. Cl. H01M 4/04; B05B 1/14; B05C 5/02; B05C 9/12; H01M 4/13; H01M 4/139

(52) U.S. Cl. CPC H01M 4/0404; B05B 1/14; B05C 5/0254; B05C 9/12; H01M 4/13; H01M 4/139

(57) ABSTRACT

An apparatus for manufacturing a secondary battery electrode plate includes: a coating unit configured to coat an electrode material on an electrode substrate of a secondary battery, the coating unit including: a first coater configured to form a first coated portion of the electrode material on the electrode substrate; and a second coater configured to form a second coated portion of the electrode material on an at least one of both transverse ends of the first coated portion on the electrode substrate, the second coated portion having a thickness smaller than a thickness of the first coated portion; and a notching unit configured to cut the electrode substrate coated with the electrode material by the coating unit.

### CROSS-REFERENCE TO RELATED APPLICATION

The present application claims priority to and the benefit of Korean Patent Application No. 10-2024-0052124, filed on Apr. 18, 2024, in the Korean Intellectual Property Office, the entire disclosure of which is incorporated herein by reference.

### BACKGROUND

### 1. Field

Aspects of embodiments of the present disclosure relate to an apparatus and a method for manufacturing a secondary battery electrode plate.

### 2. Description of the Related Art

Different from primary batteries that are not designed to be (re)charged, secondary batteries are designed to be discharged and recharged. Generally, a secondary battery includes an electrode assembly including (or composed of) a positive electrode plate, a negative electrode plate, and a separator.

The positive or negative electrode plate may be manufactured by using a coating process of coating an active material mixture on one side or both sides of an electrode substrate, a rolling pressing process of pressing and stretching the coated electrode plate to make the electrode plate thin and flat, a slitting process of cutting the coated electrode plate in multiple rows in a machine direction and separating the electrode plate into individual electrode plates, and a notching process of cutting each separated electrode plate in a transverse direction, removing an unnecessary portion, and forming a tab.

After the substrate is subjected to coating, rolling, and slitting, the substrate is cut in the transverse direction to form the tab during the notching process, and in a subsequent assembly process, a process is performed to produce an electrode plate for manufacturing an electrode assembly. However, a portion of the coated portion may be cut off in the notching process to cause loss.

The above information disclosed in this Background section is for enhancement of understanding of the background of the present disclosure, and therefore, it may contain information that does not constitute related (or prior) art.

### SUMMARY

According to embodiments of the present disclosure, loss that occurs when a portion of a coated portion is cut off in a notching process is reduced.

According to an embodiment of the present disclosure, an apparatus for manufacturing a secondary battery electrode plate includes: a coating unit configured to coat an electrode material on an electrode substrate of a secondary battery; and a notching unit configured to cut the electrode substrate coated with the electrode material by the coating unit. The coating unit includes: a first coater configured to form a first coated portion of the electrode material on the electrode substrate; and a second coater configured to form a second coated portion of the electrode material on the electrode substrate on an at least one of both transverse ends of the first coated portion. The second coated portion has a thickness smaller than a thickness of the first coated portion.

According to another embodiment of the present disclosure, a method for manufacturing a secondary battery electrode plate includes: a coating process of coating an electrode material on an electrode substrate of a secondary battery; and a notching process of cutting the electrode substrate coated with the electrode material in the coating step. The coating process includes: a first coating step of forming a first coated portion of the electrode material on the electrode substrate; and a second coating step of forming a second coated portion of the electrode material on the electrode substrate on at least one of both transverse ends of the first coated portion. The second coating portion has a thickness smaller than a thickness of the first coated portion.

According to another embodiment of the present disclosure, a secondary battery electrode plate includes: a first coated portion; and a second coated portion on at least one of both transverse ends of the first coated portion and having a thickness smaller than a thickness of the first coated portion.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings:

FIG. 1 schematically illustrates an electrode assembly of a secondary battery;

FIG. 2 schematically illustrates a pouch-type secondary battery;

FIG. 3 is a cross-sectional view of a cylindrical secondary battery;

FIG. 4 illustrates an internal configuration of a prismatic secondary battery;

FIG. 5 is a schematic diagram for describing a process of manufacturing an electrode plate of the electrode assembly illustrated in FIG. 1;

FIG. 6 illustrates a single-row coated electrode plate coated by the coating unit illustrated in FIG. 5;

FIG. 7 illustrates a multi-row coated electrode plate coated by the coating unit illustrated in FIG. 5;

FIG. 8 is for schematic description of a notching process and illustrates the shape of an electrode plate before and after notching;

FIG. 9 illustrates a planar shape of a coated portion of a single-row coated electrode plate according to some embodiments of the present disclosure;

FIG. 10 illustrates a cross-sectional view of the electrode plate taken along the line A-A′ in FIG. 9;

FIG. 11 illustrates a planar shape of a coated portion of a multi-row coated electrode plate according to some other embodiments of the present disclosure;

FIG. 12 illustrates a cross-sectional view of the electrode plate taken along the line B-B′ in FIG. 11;

FIGS. 13A to 13C are schematic views of a coating unit for forming a first coated portion and a second coated portion according to some embodiments of the present disclosure;

FIG. 14 illustrates a wide spacer in a slot die for multi-row coating;

FIG. 15 illustrates a small-width spacer in a slot die for small-width coating;

FIG. 16 is a schematic diagram for describing multi-stage coating according to embodiments of the present disclosure;

FIG. 17 is a schematic diagram for describing the loss reduction effect according to embodiments of the present disclosure;

FIG. 18 illustrates a second coated portion according to another embodiment of the present disclosure;

FIG. 19 illustrates a stack state of a negative electrode plate and a positive electrode plate illustrated in FIG. 18; and

FIG. 20 illustrates another stack state of a negative electrode plate and a positive electrode plate illustrated in FIG. 18;

FIG. 21 is a view of a secondary battery module in which secondary batteries are arranged according to one or more embodiments of the present disclosure;

FIG. 22 is a view of a secondary battery pack including the secondary battery module illustrated in FIG. 21; and

FIG. 23 is a schematic view of a vehicle including the secondary battery pack illustrated in FIG. 22.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of one or more embodiments of the present disclosure and do not represent all of the aspects and features of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of about 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being

“linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

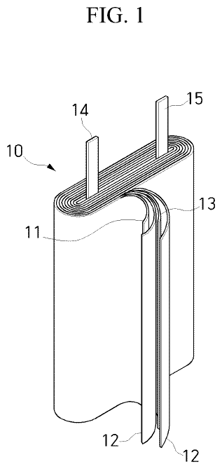

FIG. 1 shows an electrode assembly of a secondary battery.

Referring to FIG. 1, an electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to the longitudinal direction of a case. In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

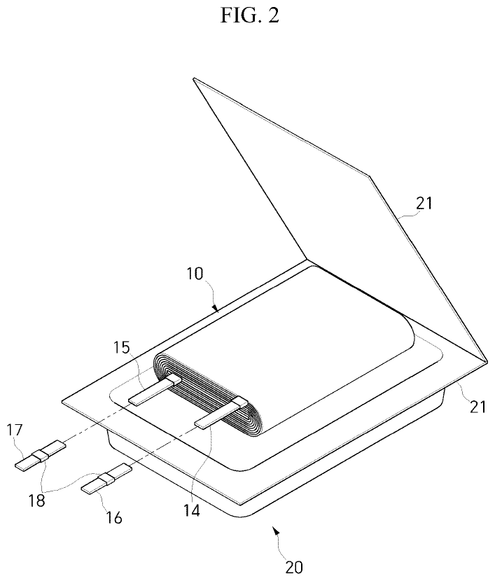

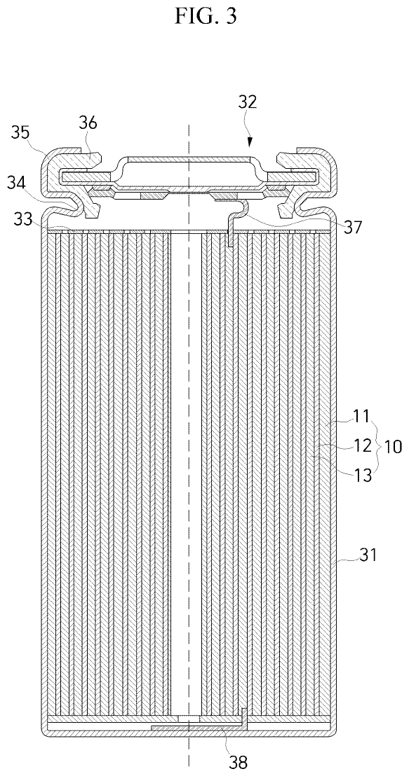

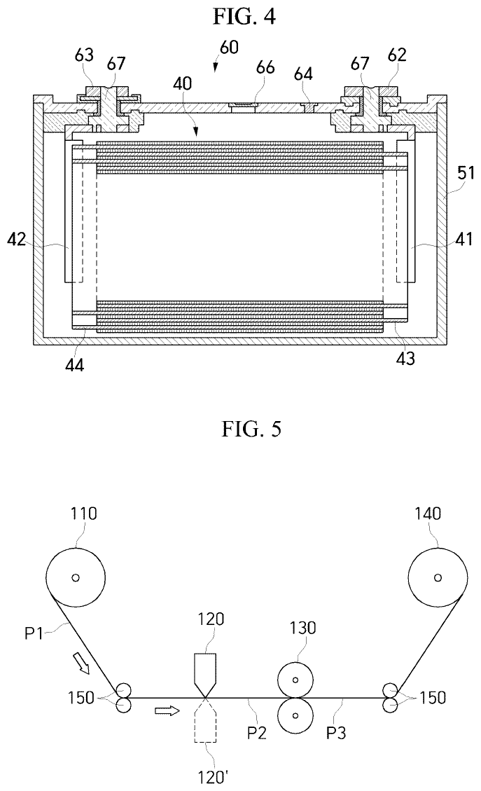

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

FIG. 2 schematically illustrates the pouch-type secondary battery.

The pouch-type secondary battery includes an electrode assembly 10 and a pouch 20 that accommodates the electrode assembly 10.

The electrode assembly 10 may be the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with (e.g., covered by) a tab film 18 for insulation from the pouch 20.

The pouch 20 may be sealed by having sealing parts 21 at the edges thereof come into contact with each other while accommodating the electrode assembly 10 therein, and the sealing may be achieved with the tab film 18 interposed between the sealing parts 21. The sealing parts 21 of the pouch 20 may each be made of a thermal fusion material that generally exhibits weak adhesion to metal. Thus, the pouch 20 may be fused together by interposing the thin film 18 between the sealing parts 21 to ensure a sufficient seal.

FIG. 3 illustrates a cylindrical secondary battery. As shown in FIG. 3, a secondary battery may include an electrode assembly 10, a case 31 accommodating the electrode assembly 10 and an electrolyte therein, a cap assembly 32 coupled to an opening in the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 32, forms an external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of a gasket 36 and the cap assembly 32. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 shows an internal structure of a prismatic secondary battery.

As shown in FIG. 4, a prismatic secondary battery may include an electrode assembly 40, a first current collector 41, a first terminal 62, a second current collector 42, a second terminal 63, a case 51, and a cap assembly 60.

The electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In other embodiments, the electrode assembly 40 may be a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies 40 may be stacked such that long sides of the electrode assemblies 40 are adjacent to each other and accommodated in the case 51, and the number of electrode assemblies 40 in the case 51 is not limited in the present disclosure. The first electrode plate of the electrode assembly may act as a negative electrode, and the second electrode plate may act as a positive electrode. Of course, the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As described above, in embodiments in which the first electrode tab 43 and the second electrode tab 44 are located at the top of the electrode assembly 40, the first and second current collectors are located at the top of the electrode assembly 40.

As illustrated in FIG. 4, the first current collector 41 and the second current collector 42 are connected to the first terminal 62 and the second terminal 63 through connection members 67, respectively. In some embodiments, the connection members 67 may each have an outer peripheral surface that is threaded and may be fastened to the first terminal 62 and the second terminal 63 by screwing. However, the present disclosure is not limited thereto. In other embodiments, the connection members 67 may be coupled to the first terminal 62 and the second terminal 63 by riveting or welding.

FIG. 5 is a schematic diagram describing a process for manufacturing an electrode plate (e.g., the first electrode plate 11 or the second electrode plate 13) of the electrode assembly 10 illustrated in FIG. 1 or the electrode assembly 40 illustrated in FIG. 4.

A supply roll 110 is a roll on which a substrate P1 for an electrode plate is wound. When an apparatus for manufacturing electrode plates according to embodiments the present disclosure is used to manufacture a positive electrode plate, the substrate P1 may be a metal foil including (or containing) aluminum (Al), for example. Alternatively, when the apparatus for manufacturing electrode plates according to embodiments of the present disclosure is used to manufacture a negative electrode plate, the substrate P1 may be a metal foil including (or containing) copper (Cu) or nickel (Ni).

A transfer roller 150 may be an idle roller that guides the substrate P1 as it is unwounded from the supply roll 110 or a drive roller that applies a pulling force to unwind the substrate P1 from the supply roll 110. FIG. 5 illustrates an embodiment including a total of four transfer rollers 150 as an example only, and the number and positions of transfer rollers may be varied.

A coating unit 120 forms a coating layer by coating the substrate P1 with an electrode material slurry that is previously prepared. The slurry for coating includes (or contains) an active material. When the apparatus for manufacturing electrode plates according to embodiments of the present disclosure is used to manufacture the positive electrode plate, the slurry may include (or contain) an active material containing a transition metal oxide, a binder, a volatile solvent, and the like, for example. When the apparatus is used to manufacture the negative electrode plate, the slurry may be prepared with (e.g., may include) an active material containing a transition metal oxide, a binder, a solvent, or the like. Moreover, both surfaces, namely the upper and lower surfaces, of the substrate P1 may be coated (e.g., may be concurrently or simultaneously coated) by adding a second coating unit 120′, having the same configuration as the coating unit 120 illustrated in FIG. 5, to the lower surface of the substrate P1.

A press unit (e.g., a rolling unit) 130 includes a rolling roller to compresses an electrode plate P2 coated with the slurry (e.g., a mixture of materials) by the coating unit 120 to produce a high-capacity and high-density secondary battery.

A winding roll 140 is a roll that winds and accommodates an electrode plate P3 coated by the coating unit 120 and rolled by the press unit 130.

FIG. 6 illustrates the substrate P2 coated with the electrode material by the coating unit 120 shown in FIG. 5. The coated substrate P2 has a coated portion 72 at where the active material mixture is coated on the substrate, and an uncoated portion 74 that is not coated with the active material mixture. Hereinafter, the width direction of the electrode plate is referred to as a transverse direction TD, and the longitudinal direction, which is the travel direction of the electrode plate, is referred to as a machine direction MD.

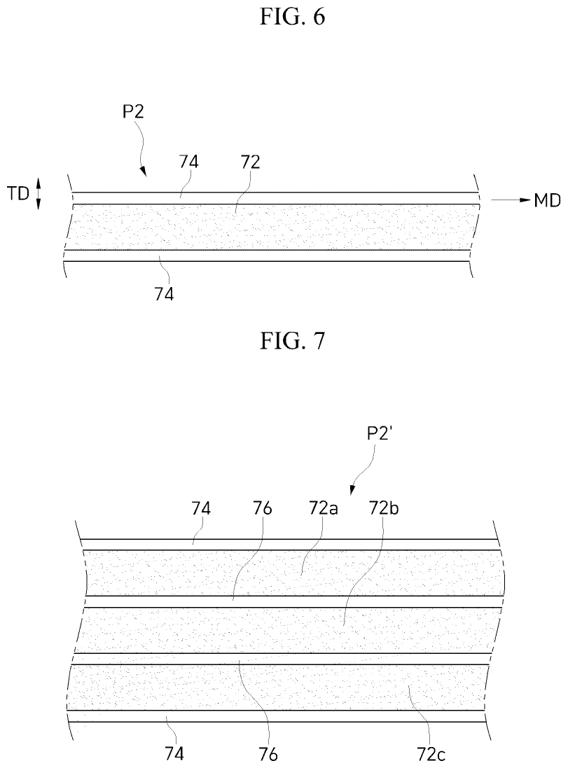

The coating unit 120 may include a device (e.g., a multi-row coating slot die) that concurrently (or simultaneously) coats several rows of coating areas of the substrate in the transverse direction TD. FIG. 7 illustrates a multi-row coated substrate P2′ in which coated portions are formed in multiple rows by such a multi-row coating device and illustrates an embodiment in which a first-row coated portion 72a, a second-row coated portion 72b, and a third-row coated portion 72c are located (or are arranged) side by side in the transverse direction TD with uncoated portions 76 as boundaries. An uncoated portion 74 may exist even at the outermost portion of the multi-row coated electrode plate. Thus, in the multi-row coated electrode plate described above, the uncoated portions 76 from among the first-row coated portion 72a, the second-row coated portion 72b, and the third-row coated portion 72c may be cut in the machine direction (MD) during a slitting process so that the multi-row coated electrode plate may be separated into individual electrode plates respectively formed by the first-row coated portion 72a, the second-row coated portion 72b, and the third-row coated portion 72c.

The multi-row coated substrate P2′ illustrated in FIG. 7 becomes individual electrode plates after they are separated by the slitting, or the single-row coated substrate P2 illustrated in FIG. 6 becomes a final electrode plate to be stacked in a subsequent electrode assembly process through processes such as cutting in the transverse direction TD during a notching process by a subsequent notching unit, removal of an unnecessary uncoated portion, and formation of a tab from an uncoated portion.

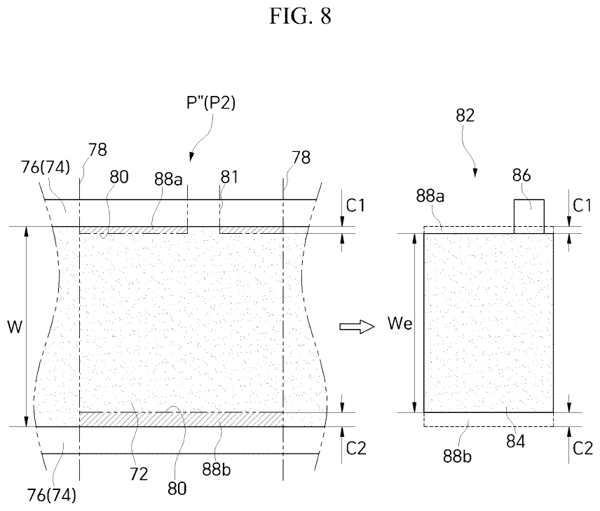

FIG. 8 is a schematic description of a notching process and illustrates the shape of an electrode plate before and after notching.

Each substrate P″ individually separated from the multi-row coated substrate P2′ illustrated in FIG. 7 by slitting, or the single-row coated substrate P2 illustrated in FIG. 6, may be cut in the transverse direction along a transverse-direction cutting line 78 and in the machine direction along a machine-direction cutting line 80 by the notching unit during the notching process. The notching unit may remove and organize the uncoated portions 76 and 74 along a shaping line 81. The notched electrode plate 82 has an area 84 coated with a positive electrode material or a negative electrode material and a tab 86, which is an uncoated area, as illustrated on the right side of FIG. 8. The tab 86 is a portion to which a conductive member, such as a current collector or a subplate, is bonded during a subsequent electrode assembly process.

When the notching unit removes the uncoated portions 76 and 74 to shape the electrode plate, a portion of the coated area 84 may be cut off. In FIG. 8, coated portions that may be cut off by the notching unit are indicated by reference numerals 88a and 88b. Reference numeral 88a denotes a coated portion that may be cut off from the side where the tab 86 is formed, and reference numeral 88b denotes a coated portion that may be cut off from the side opposite to the side where the tab 86 is formed.

For an example of the size of a portion that may be cut off, in FIG. 8, when coating is performed with a width W of about 200 mm in the coating process, a width C1 of the coated portion 88a that is cut off from the tab 86 side may be about 0.5 mm and a width C2 of the coated portion 88b cut off from the opposite side of the tab 86 may be about 3 mm during the notching process, so that an effective width We of the coated area 84 is reduced to about 196.5 mm. In such a case, an electrode plate composition material (e.g., active material, binder, substrate, conductive material, etc.) with a width corresponding to the cut-off portions (3.5 mm=0.5 mm+3 mm) is lost.

To reduce loss due to the partial removal of the electrode material coated area 84 during the notching, embodiments of the present disclosure change the profile of the coated area in the coating process.

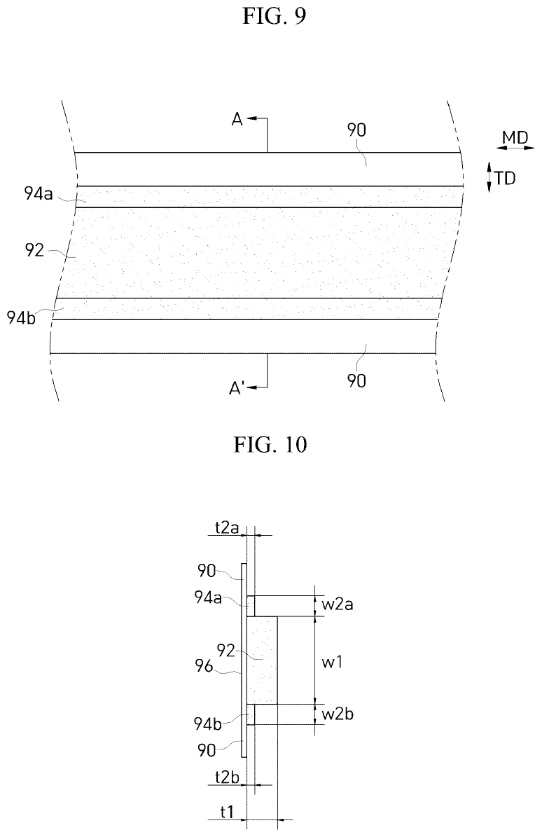

FIG. 9 illustrates a planar shape of a coated portion of a single-row coated electrode plate by a coating device according to some embodiments of the present disclosure, and FIG. 10 illustrates a cross-sectional shape thereof taken along the line A-A′ in FIG. 9.

A first coated portion 92 and second coated portions 94a and 94b may be formed on a substrate 96. The first coated portion 92 may be formed to have the same thickness and material as a coated area in the related art. The second coated portions 94a and 94b may be formed on at least one of both transverse ends of the first coated portion 92 and may be formed to have a lower (or smaller) thickness than the first coated portion 92. In some embodiments, one second coated portion 94a may be in contact with the side edge of one end of the first coated portion 92 and formed to have a lower thickness than the first coated portion 92, and the other second coated portion 94b may be in contact with the side edge of the other end of the first coated portion 92 and formed to have a lower thickness than the first coated portion 92. In some other embodiments, the second coated portion 94a or 94b may be formed only on the side edge of one of both ends of the first coated portion 92, which will be described in more detail below.

The second coated portions 94a and 94b may each be formed to have a width smaller than the width of the first coated portion 92, may not reach (e.g., may not extend to) the outer peripheral line of the substrate 96, and may each be coated while leaving an uncoated portion 90.

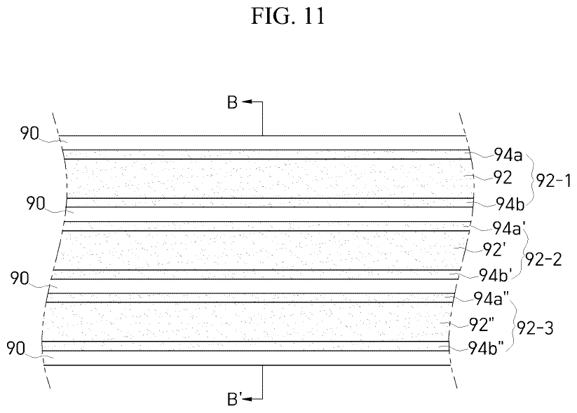

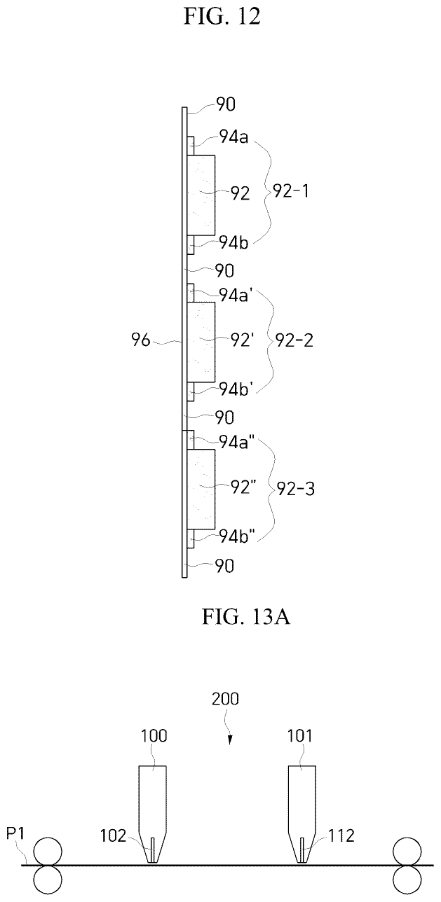

FIGS. 11 and 12 illustrate a planar shape of a coated portion of a multi-row electrode plate coated by a coating device according to some other embodiments of the present disclosure and a cross-sectional shape thereof taken along line B-B′ in FIG. 11, respectively.

A first row coated portion 92-1, a second row coated portion 92-2, and a third row coated portion 92-3 may be formed on the substrate 96 with the uncoated portion 90 as a boundary. Similar to the single-row coated electrode plate illustrated in FIGS. 9 and 10, the first row coated portion 92-1 may include the first coated portion 92 and the second coated portions 94a and 94b. The second row coated portion 92-2 may include a first coated portion 92′ and second coating portions 94a′ and 94b′. The third row coated portion 92-3 may include a first coated portion 92″ and second coating portions 94a″ and 94b″. In a subsequent slitting process, the first row coated portion 92-1, the second row coated portion 92-2, and the third row coated portion 92-3 are cut and separated along the uncoated portions 90 serving as boundary lines between the first row coated portion 92-1, the second row coated portion 92-2, and the third row coated portion 92-3.

Also, in this embodiment, the first coated portions 92, 92′, and 92″ may be formed to have the same thickness and material as a coated area in the related art, and the second coated portions 94a and 94b, 94a′ and 94b′, and 94a″ and 94b″ may be formed to have a relatively low (e.g., lower or smaller) thickness and/or narrower width on the side edge of at least one of both transverse ends of the first coated portions 92, 92′, and 92″, respectively.

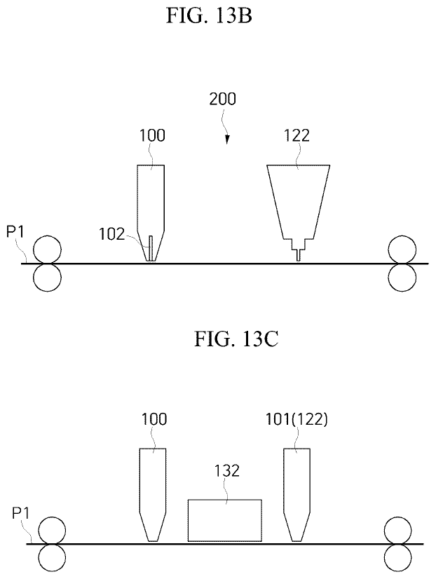

FIGS. 13A to 13C are schematic views of a coating unit for forming the above-described first coated portion 92 and second coated portions 94a and 94b.

A coating unit 200 may include a first coater 100 that forms the first coated portions 92, 92′, and 92″ on the substrate 96, and a second coater 101 that forms the second coated portions 94a and 94b, 94a′ and 94b′, and 94a″ and 94b″ on the substrate 96.

In the embodiment illustrated in FIG. 13A, the first coater 100 may include a wide spacer 102 used in a slot die for multi-row coating and the second coater 101 may include a small-width spacer 112 used in a slot die for small-width coating.

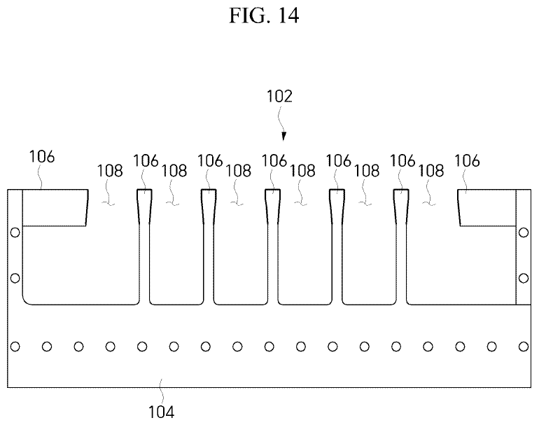

FIG. 14 illustrates the wide spacer 102 in the slot die for multi-row coating. This wide spacer 102 may include a spacer body 104 mounted on the slot die, a plurality of partition walls 106 protruding from positions corresponding to uncoated portions to be boundaries of respective coated areas, and a plurality of slurry discharge ports 108 through which a mixture slurry comes out between the partition walls 106.

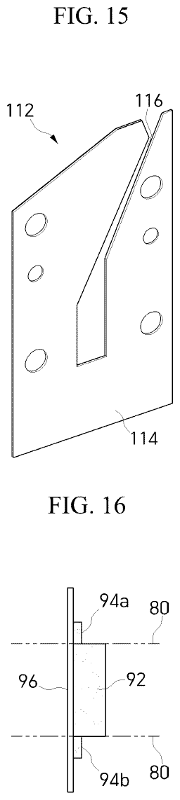

FIG. 15 illustrates the small-width spacer 112 in the slot die for small-width coating. The small-width spacer 112 may include a spacer body 114 mounted on the slot die and a slurry discharge port 116 through which the mixture slurry comes out.

In the embodiment illustrated in FIG. 13B, the first coater 100 may include the wide spacer 102, and a second coater 122 may be a sprayer that sprays a mixture slurry.

In FIGS. 13A and 13B, the first coater 100 and the second coaters 101 or 122 are illustrated for single-sided coating of the substrate 96; however, another first coater and another second coater for double-sided coating may be additionally provided (see, e.g., FIG. 5).

Referring to FIG. 13C, a dryer 132 may be provided between the first coater 100 and the second coater 101 or 122. The dryer 132 may dry the first coated portions 92, 92′, and 92″ formed by the first coater 100. The second coater 101 or 122 forms the second coated portions 94a and 94b, 94a′ and 94b′, and 94a″ and 94b at both edge portions of each of the dried first coated portions 92, 92′, and 92″, respectively, thereby securing the formation of more robust coated portions.

Hereinafter, the coated portion formed by the coating device according to some embodiments of the present disclosure will be described in more detail. For convenience of understanding, the description will be made with reference to the drawings related to the single-row coated electrode plate as shown in FIGS. 9 and 10, but this description may also be applied to the multi-row coated electrode plate shown in FIGS. 11 and 12.

A thickness t1 and a width w1 of the first coated portion 92 may be formed to a level substantially equal to a final thickness and width for when an electrode plate is manufactured.

In some embodiments, a thickness t2a of the second coated portion 94a on one side and a thickness t2b of the second coated portion 94b on the other side may be the same as each other. In some other embodiments, the thickness t2a of the second coated portion 94a on one side and the thickness t2b of the second coated portion 94b on the other side may be different from each other.

The thickness t2a of the second coated portion 94a on one side and/or the thickness t2b of the second coated portion 94b on the other side may be in a range of about 5 μm to about 100 μm. This thickness may be a value measured after the coated portion is dried.

In some embodiments, the thickness t2a and/or the thickness t2b may be about 50% or less of the thickness t1 of the first coated portion 92. In some other embodiments, the thickness t2a and/or the thickness t2b may be about 30% or less of the thickness t1.

In some embodiments, a width w2a of the second coated portion 94a on one side and a width w2b of the second coated portion 94b on the other side may be the same as each other. In some other embodiments, the width w2a of the second coated portion 94a on one side and the width w2b of the second coated portion 94b on the other side may be different from each other.

In some embodiments, the width w2a of the second coated portion 94a on one side and/or the width w2b of the second coated portion 94b on the other side may be in a range of about 2 mm to 5 mm. This thickness may be a value measured after the coated portion is dried. In some other embodiments, the width w2a of the second coated portion 94a on one side or the width w2b of the second coated portion 94b on the other side may be zero (0). For example, one of the second coated portion 94a on one side and the second coated portion 94b on the other side may not be formed.

When the coating material for the second coated portions 94a and 94b is manufactured, the amount of an active material, which has a high unit cost (e.g., is expensive), is reduced compared to the coating material for the first coated portion 92 to reduce loss due to cutting during notching. In some embodiments, in the coating material composition of the second coated portions 94a and 94b, the ratio of active material:binder may be in a range of about 1:9 wt % to about 8:2 wt %, and a solvent, such as N-Methyl-2-pyrrolidone (NMP), may be mixed to adjust viscosity. To reduce the amount of active material input, a filler, such as calcium carbonate, silica, and/or Boehmite, may be added in addition to the active material and the binder.

FIG. 16 describes the multi-stage coating according to embodiments of the present disclosure.

Even though the coated portion is cut along the cutting line 80 in the notching process, portions that are cut and discarded may primarily be the second coated portions 94a and 94b. As described above, the second coated portions 94a and 94b have a relatively low content of active material in the coating material and a relatively small coating thickness, resulting in low material consumption. Accordingly, the amount of the first coated portion 92 discarded during notching is greatly reduced compared to the related art so that overall loss is reduced.

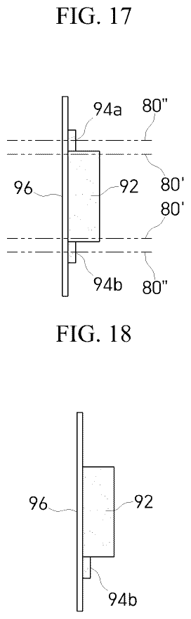

FIG. 17 describes the loss reduction effect according to embodiments of the present disclosure even in the event of positional deviation of the cutting line 80.

If a cutting line 80′ enters the inside of the first coated portion 92, although a small amount of the first coated portion 92 is cut, it is insignificant compared to the cutting amount in the related art and still reduces the overall loss compared to the related art.

In the case of a cutting line 80″ deviating from the first coated portion 92 and entering the inside of the second coated portions 94a and 94b, the first coated portion 92 remains intact and some of the second coated portions 94a and 94b also remain, but because the second coated portions 94a and 94b themselves may also act as electrodes (e.g., as active parts of an electrode), a decrease in electrode performance is insignificant.

FIG. 18 illustrates second coated portions 94a and 94b according to another embodiment.

As described above, the thicknesses or widths of the second coated portion 94a on one side and the second coated portion 94b on the other side may be different from each other, and the width w2a of the second coated portion 94a on one side or the width w2b of the second coated portion 94b on the other side may be zero (0). FIG. 18 illustrates such an embodiment.

In the embodiment illustrated in FIG. 10, the second coated portions 94a and 94b are formed on both edge portions of the first coated portion 92. In such an embodiment, as illustrated in FIG. 8, one second coated portion 94a is formed on the side where the tab 86 is located and another second coated portion 94b is formed on the opposite side of the tab 86. When the second coated portions 94a and 94b are formed in this way, an N/P inversion (negative-positive ratio inversion) phenomenon, in which a N/P ratio is abnormally inverted, may occur when a negative electrode plate and a positive electrode plate are stacked. For example, when cutting is performed along the cutting line 80″ shown in FIG. 17, the possibility of the N/P inversion occurring further increases.

To prevent or reduce the chances of the N/P inversion, as illustrated in FIG. 18, the second coated portion 94a of the second coated portions 94a and 94b may not be formed on the side adjacent to the tab 86, but the second coated portion 94b may be formed on the opposite side of the tab 86.

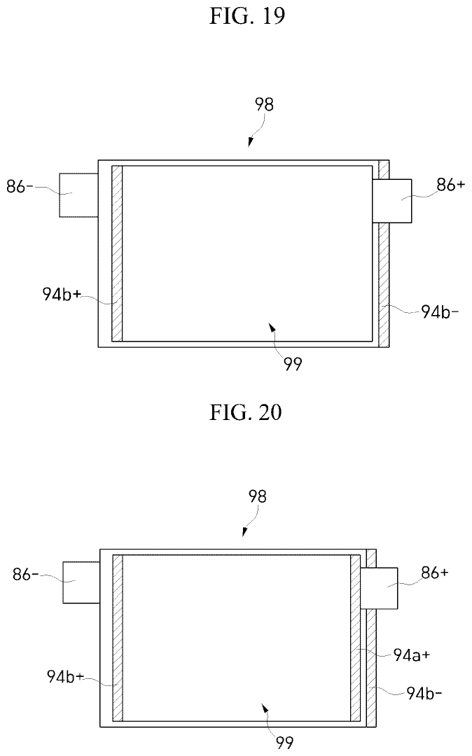

FIG. 19 illustrates a state in which a negative electrode plate and a positive electrode plate with the second coated portion 94b formed on only one side are stacked as described above. In FIG. 19, a negative electrode plate 98 has a second coated portion 94b—formed only on the opposite side of a tab 86—and a positive electrode plate 99 has a second coated portion 94b+ formed only on the opposite side of a tab 86+. In FIG. 19, the sizes of the negative electrode plate 98 and the positive electrode plate 99 are expressed differently to show overlap therebetween.

However, because most N/P inversions occur in the negative electrode plate, unlike the cases of FIGS. 18 and 19, as shown in FIG. 20, the second coated portion 94b—may be formed on the negative electrode plate 98 only on the opposite side of the tab 86—, and the second coating portions 94a+ and 94b+ may be formed on the positive electrode plate 99 both on the side adjacent to and on the opposite side of the tab 86+.

A method for manufacturing a secondary battery electrode plate according to some embodiments of the present disclosure may include: a coating process of coating an electrode material on an electrode substrate of a secondary battery; and a notching process of cutting the substrate coated with the electrode material in the coating step. The coating process may include: a first coating step of forming the first coated portion 92; and a second coating step of forming the second coated portions 94a and 94b each having a thickness smaller than the thickness of the first coated portion 92 on at least one of both transverse ends of the first coated portion 92.

In some embodiments, the method may include a drying step of drying the first coated portion 92 between the first coating step and the second coating step. Thus, the first coated portion 92 formed in the first coating step may be sufficiently dried before entering the second coating step.

The first coating step may be performed by using a slot die for multi-row coating, and the wide spacer 102 may be used in the slot die for multi-row coating.

The second coating step may be performed by using a slot die for small-width coating, and the small-width spacer 112 may be used in the slot die for small-width coating. In some other embodiments, the second coating step may be performed by using a sprayer 120 that sprays an electrode material slurry.

The electrode material used in the second coating step may contain a smaller amount of active material than the electrode material used in the first coating step.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

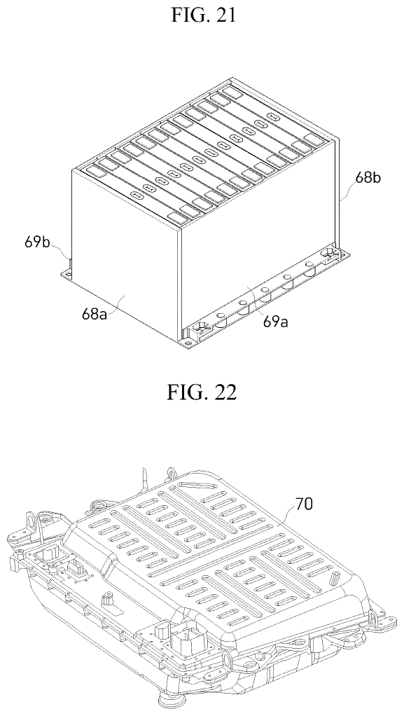

FIG. 21 is a perspective view of a secondary battery module in which prismatic secondary batteries are arranged according to embodiments of the present disclosure. With the increase in secondary battery capacity for driving electric vehicles or the like, a secondary battery module may be manufactured by arranging a plurality of secondary battery cells transversely and/or longitudinally and connecting them together. The plurality of secondary batteries may be arranged in a space defined by a pair of facing end plates 68a and 68b and a pair of facing side plates 69a and 69b. The secondary batteries may be arranged in an arrangement (direction) and number to obtain desired voltage and current specifications.

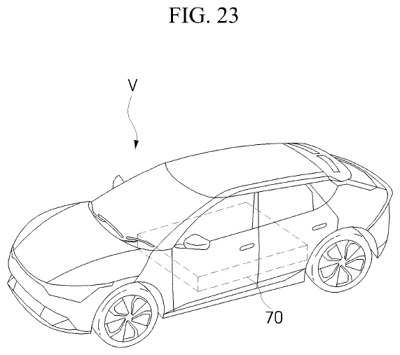

FIG. 22 is a perspective view of a battery pack 70 according to embodiments of the present disclosure. Referring to FIG. 22, the battery pack 70 may include an assembly to which individual batteries are electrically connected and a pack housing accommodating the same. In the drawings, for convenience of illustration, components including a bus bar, a cooling unit, external terminals for electrically connecting batteries, etc., are not shown.

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 23 shows a vehicle V that includes the battery pack 70 shown in FIG. 22 on the lower body thereof. The vehicle V may operate by (e.g., may be powered by) receiving power from the battery pack 70.

According to embodiments of the present disclosure, a second coated portion having a portion to be cut in a notching process is formed by using a material having a smaller thickness than a first (or central) coated portion and containing a smaller amount of active material than the first coated portion so that the loss (e.g., the loss of active material) in the cut portion may be reduced.

Aspects and features of the present disclosure, and effects that can be obtained therethrough, are not limited to the above-described aspects and features, and other aspects and features will be clearly understood by those skilled in the art from the description of embodiments of the present disclosure below.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. An apparatus for manufacturing a secondary battery electrode plate, the apparatus comprising:
a coating unit configured to coat an electrode material on an electrode substrate of a secondary battery, the coating unit comprising:
a first coater configured to form a first coated portion of the electrode material on the electrode substrate; and
a second coater configured to form a second coated portion of the electrode material on an at least one of both transverse ends of the first coated portion on the electrode substrate, the second coated portion having a thickness smaller than a thickness of the first coated portion; and
a notching unit configured to cut the electrode substrate coated with the electrode material by the coating unit.

2. The apparatus as claimed in claim 1, wherein the first coater comprises a wide spacer used in a slot die for multi-row coating.

3. The apparatus as claimed in claim 1, wherein the second coater comprises a small-width spacer used in a slot die for small-width coating.

4. The apparatus as claimed in claim 1, wherein the second coater comprises a sprayer configured to spray a slurry of the electrode material.

5. The apparatus as claimed in claim 1, wherein the coating unit further comprises a drier between the first coater and the second coater and configured to dry the first coated portion.

6. The apparatus as claimed in claim 1, wherein the first coated portion is formed in multiple rows on the electrode substrate.

7. The apparatus as claimed in claim 1, wherein a transverse width of the second coated portion is smaller than a transverse width of the first coated portion.

8. The apparatus as claimed in claim 1, wherein an electrode material of the second coated portion contains a smaller amount of an active material than an electrode material of the first coated portion.

9. The apparatus as claimed in claim 1, wherein the thickness of the second coated portion is 50% or less of the thickness of the first coated portion.

10. A method for manufacturing a secondary battery electrode plate, the method comprising:
a coating process of coating an electrode material on an electrode substrate of a secondary battery, the coating process comprising:
a first coating step of forming a first coated portion of the electrode material on the electrode substrate; and
a second coating step of forming a second coated portion of the electrode material on the electrode substrate on at least one of both transverse ends of the first coated portion, the second coated portion having a thickness smaller than a thickness of the first coated portion; and
a notching process of cutting the electrode substrate coated with the electrode material.

11. The method for manufacturing a secondary battery electrode plate as claimed in claim 10, wherein the coating process further comprises a drying step between the first coating step and the second coating step to dry the first coated portion.

12. The method for manufacturing a secondary battery electrode plate as claimed in claim 10, wherein the first coating step is performed by using a slot die for multi-row coating.

13. The method for manufacturing a secondary battery electrode plate as claimed in claim 10, wherein the second coating step is performed by using a slot die for small-width coating.

14. The method for manufacturing a secondary battery electrode plate as claimed in claim 10, wherein the second coating step is performed by using a sprayer that sprays a slurry of the electrode material.

15. The method for manufacturing a secondary battery electrode plate as claimed in claim 10, wherein the electrode material used in the second coating step contains a smaller amount of active material than the electrode material used in the first coating step.

16. A secondary battery electrode plate coated with an electrode material on an electrode substrate, the secondary battery electrode plate comprising:
a first coated portion; and
a second coated portion on at least one of both transverse ends of the first coated portion and having a thickness smaller than a thickness of the first coated portion.

17. The secondary battery electrode plate as claimed in claim 16, wherein the first coated portion comprises multiple rows on the electrode substrate.

18. The secondary battery electrode plate as claimed in claim 16, wherein a transverse width of the second coated portion is smaller than a transverse width of the first coated portion.

19. The secondary battery electrode plate as claimed in claim 16, wherein an electrode material of the second coated portion contains a smaller amount of an active material than an electrode material of the first coated portion.

20. The secondary battery electrode plate as claimed in claim 16, wherein the thickness of the second coated portion is 50% or less of the thickness of the first coated portion.
